(19) United States
(12) Patent Application Publication
(10) Pub. No.: US 2025/0212139 A1
(43) Pub. Date: Jun. 26, 2025

(54) DEVICE TRANSMISSION POWER CONTROL

(71) Applicant: Cisco Technology, Inc., San Jose, CA (US)

(72) Inventors: Sachin D. WAKUDKAR, St-Sulpice (CH); Jerome HENRY, Pittsboro, NC (US); Robert E. BARTON, Richmond (CA); Brian D. HART, Sunnyvale, CA (US); Nedime Pelin MOHAMED HASSAN SALEM, San Jose, CA (US)

(21) Appl. No.: 18/617,439

(22) Filed: Mar. 26, 2024

Related U.S. Application Data
(60) Provisional application No. 63/613,728, filed on Dec. 21, 2023.

(51) Int. Cl. H04W 52/36; H04W 52/28; H04W 84/12

(52) U.S. Cl. CPC H04W 52/367; H04W 52/283; H04W 84/12

(57) ABSTRACT

The present disclosure describes a wireless network that reduces a total transmission power of a device so that the device can operate in the standard power mode. An access point includes a memory and a processor communicatively coupled to the memory. The processor determines a location of a first device, determines, based on the location of the first device, that the first device is allowed to transmit using a first amount of power for a WiFi radio of the first device, and, in response to determining that a total power transmitted by the first device would exceed a threshold transmission power if the first device transmitted using the first amount of power, reduces a power transmitted by at least one radio of the first device so that the first device is allowed to transmit using the first amount of power for the WiFi radio of the first device.

### CROSS-REFERENCE TO RELATED APPLICATIONS

This application claims benefit of co-pending U.S. provisional patent application Ser. No. 63/613,728 filed Dec. 21, 2023. The aforementioned related patent application is herein incorporated by reference in its entirety.

### TECHNICAL FIELD

Embodiments presented in this disclosure generally relate to wireless communication. More specifically, embodiments disclosed herein a technique or process for controlling the transmission power of a device.

### BACKGROUND

Devices may communicate with different networks using different communication protocols (e.g., wireless fidelity (WiFi), cellular, Bluetooth, ultra-wideband (UWB)). A WiFi network may use automated frequency coordination (AFC) to determine whether a device should operate in a low power mode or a standard power mode depending on the device's location. In the standard power mode (which is usually allowed when the device is indoors), the device may use a higher transmission power than in the low power mode. Allowing the device to use the higher transmission power, however, may cause the total transmit power of the device to exceed legal regulations or requirements.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIGS. 1A and 1B illustrate an example system.

FIG. 2 illustrates an example operation performed by the system of FIG. 1A.

FIG. 3 illustrates an example operation performed by the system of FIG. 1A.

FIG. 4 illustrates an example operation performed by the system of FIG. 1A.

FIG. 5 illustrates an example instruction in the system of FIG. 1A.

FIG. 6 illustrates an example operation performed by the system of FIG. 1A.

FIG. 7 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### Description of Example Embodiments

### Overview

The present disclosure describes a wireless network (e.g., a WiFi network) that reduces a total transmission power of a device so that the device can operate in the standard power mode. According to an embodiment, an access point includes one or more memories and one or more processors communicatively coupled to the one or more memories. A combination of the one or more processors determines a location of a first device and determines, based on the location of the first device, that the first device is allowed to transmit using a first amount of power for a WiFi radio of the first device. The combination of the one or more processors also, in response to determining that a total power transmitted by the first device would exceed a threshold transmission power if the first device transmitted using the first amount of power for the WiFi radio of the first device, instructs the first device to reduce the total power transmitted by the first device so that the first device is allowed to transmit using the first amount of power for the WiFi radio of the first device.

According to another embodiment, a method includes determining, by an access point, a location of a first device and determining, by the access point and based on the location of the first device, that the first device is allowed to transmit using a first amount of power for a wireless fidelity (WiFi) radio of the first device. The method also includes, in response to determining that a total power transmitted by the first device would exceed a threshold transmission power if the first device transmitted using the first amount of power for the WiFi radio of the first device, instructing, by the access point, the first device to reduce the total power transmitted by the first device so that the first device is allowed to transmit using the first amount of power for the WiFi radio of the first device.

According to another embodiment, a non-transitory computer readable medium stores instructions that, when executed by a combination of one or more processors, cause the combination of one or more processors to determine a location of a first device, determine, based on the location of the first device, that the first device is allowed to transmit using a first amount of power for a wireless fidelity (WiFi) radio of the first device, and in response to determining that a total power transmitted by the first device would exceed a threshold transmission power if the first device transmitted using the first amount of power for the WiFi radio of the first device, instruct the first device to reduce the total power transmitted by the first device so that the first device is allowed to transmit using the first amount of power for the WiFi radio of the first device.

### Example Embodiments

The present disclosure describes a WiFi network that determines when a total transmission power of a device would exceed legal regulations or requirements if the device were to use a particular WiFi transmission power (e.g., a standard power mode). The network then instructs the device to reduce the total transmission power so that the device can use the WiFi transmission power. The device may reduce the total transmission power by reducing a transmission power of one or more radios (e.g., a cellular radio) of the device. The device may then use the WiFi transmission power to communicate with the WiFi network.

In particular embodiments, the WiFi network provides several technical advantages. For example, the WiFi network allows a device to use the standard power mode without the total transmission power of the device exceeding legal regulations or requirements. As another example, the WiFi network may allow the device to transmit messages using other protocols (e.g., cellular, Bluetooth, UWB, etc.) while communicating WiFi messages.

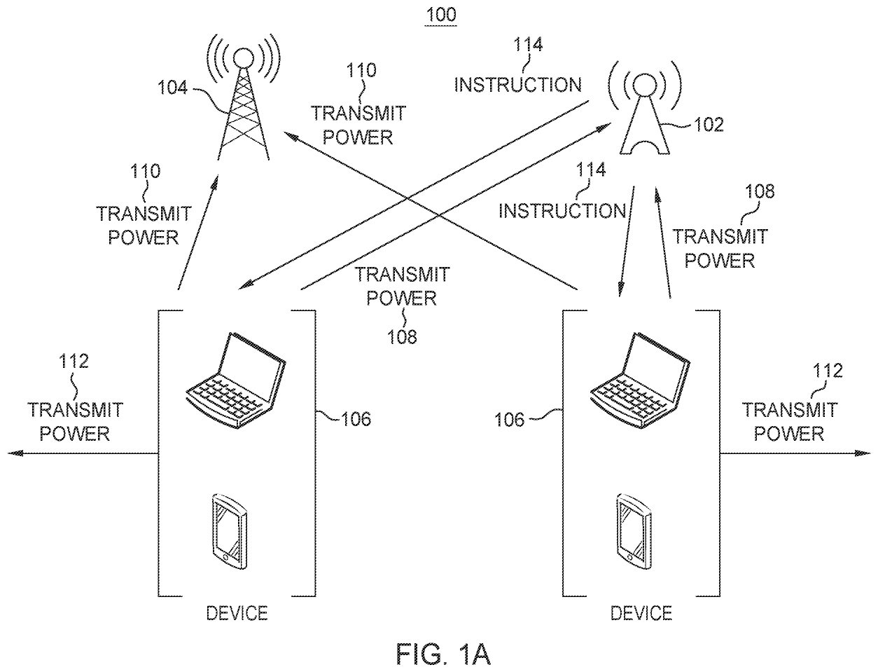

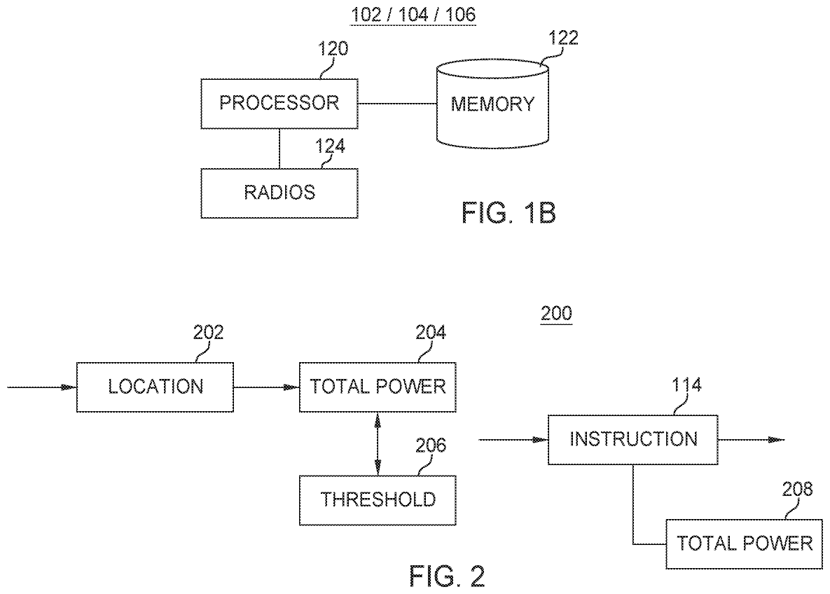

FIG. 1A illustrates an example system 100. As seen in FIG. 1A, the system 100 includes multiple wireless networks, such as a WiFi network and a cellular network. The system 100 includes one or more access points 102, one or more base stations 104, and one or more devices 106. Generally, the devices 106 connect to an access point 102 or a base station 104. The access point 102 and base station 104 provide network coverage for the system 100. The access point 102 and base station 104 communicate messages to the devices 106 and directs messages from the devices 106 towards their destination.

The access point 102 facilitates wireless communication (e.g., WiFi communication) in the system 100. One or more devices 106 may connect to the access point 102 using a WiFi protocol or process. The access point 102 may then facilitate wireless communication for the connected devices 106. For example, the access point 102 may transmit messages to a connected device 106. As another example, the access point 102 may receive messages transmitted by the device 106. The access point 102 may then direct those messages towards their intended destinations.

The base station 104 also facilitates wireless communication (e.g., cellular communication) in the system 100. One or more devices 106 may connect to the base station 104 using a cellular protocol or process. The base station 104 may then transmit messages to the connected devices 106 or receive messages from the connected devices 106. The base station 104 may direct those messages towards their intended destinations.

The device 106 may be any suitable device that wirelessly connects to the access point 102 and/or the base station 104. As an example and not by way of limitation, the device 106 may be a computer, a laptop, a wireless or cellular telephone, an electronic notebook, a personal digital assistant, a tablet, or any other device capable of receiving, processing, storing, or communicating information with other components of the system 100. The device 106 may be a wearable device such as a virtual reality or augmented reality headset, a smart watch, or smart glasses. The device 106 may also include a user interface, such as a display, a microphone, keypad, or other appropriate terminal equipment usable by the user. The device 106 may include a hardware processor, memory, or circuitry configured to perform any of the functions or actions of the device 106 described herein. For example, a software application designed using software code may be stored in the memory and executed by the processor to perform the functions of the device 106.

Generally, the devices 106 may transmit messages using different amounts of power. For example, a device 106 may transmit WiFi messages to the access point 102 using a transmit power 108, and the device 106 may transmit cellular messages to the base station 104 using a transmit power 110. The device 106 may also transmit messages using other protocols or technologies (e.g., Bluetooth, ultra-wideband (UWB), etc.) using a transmit power 112. Typically, the transmit power 110 is higher than the transmit power 108 and the transmit power 112.

Some WiFi networks may control the transmission power used by a connected device 106. For example, some WiFi networks may determine the location of a device 106 and then determine, based on the location, whether the device 106 should operate in a low power mode (e.g., to reduce interference with incumbent devices) or in a standard power mode. Generally, the device 106 uses a higher transmission power in the standard power mode than in the low power mode, and typically, the WiFi networks allow the device 106 to operate in the standard power mode when the device 106 is indoors. Operating in the standard power mode, however, may cause the total transmission power of the device 106 (e.g., the sum of the transmit power 108, transmit power 110, and transmit power 112 in the example of FIG. 1A) to exceed legal regulations or requirements.

When the access point 102 detects that the total transmit power of the device 106 would exceed legal regulations or requirements if the device 106 were to operate in the standard power mode, the access point 102 reduces the total transmit power of the device 106. The access point 102 may communicate an instruction 114 to the device to instruct the device 106 to reduce the total transmit power. The device 106 may then reduce the total transmit power. For example, the device 106 may reduce the transmit power 110 that the device 106 uses to communicate with the base station 104. After the access point 102 determines that the device 106 has reduced the total transmit power, the access point 102 may instruct the device 106 to operate in the standard power mode. In response, the device 106 then increases the transmit power 108 used to communicate with the access point 102 without the total transmit power exceeding legal regulations or requirements.

FIG. 1B illustrates an example access point 102, base station 104, or device 106 in the system 100 of FIG. 1A. As seen in FIG. 1B, the access point 102, base station 104, or device 106 includes a processor 120, a memory 122, and one or more radios 124.

The processor 120 is any electronic circuitry, including, but not limited to one or a combination of microprocessors, microcontrollers, application specific integrated circuits (ASIC), application specific instruction set processor (ASIP), and/or state machines, that communicatively couples to the memory 122 and controls the operation of the access point 102, base station 104, and/or device 106. The processor 120 may be 8-bit, 16-bit, 32-bit, 64-bit or of any other suitable architecture. The processor 120 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 120 may include other hardware that operates software to control and process information. The processor 120 executes software stored on the memory 122 to perform any of the functions described herein. The processor 120 controls the operation and administration of the access point 102, base station 104, and/or device 106 by processing information (e.g., information received from the memory 122 and radios 124). The processor 120 is not limited to a single processing device and may encompass multiple processing devices contained in the same device or computer or distributed across multiple devices or computers. The processor 120 is considered to perform a set of functions or actions if the multiple processing devices collectively perform the set of functions or actions, even if different processing devices perform different functions or actions in the set.

The memory 122 may store, either permanently or temporarily, data, operational software, or other information for the processor 120. The memory 122 may include any one or a combination of volatile or non-volatile local or remote devices suitable for storing information. For example, the memory 122 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 122, a disk, a CD, or a flash drive. In particular embodiments, the software may include an application executable by the processor 120 to perform one or more of the functions described herein. The memory 122 is not limited to a single memory and may encompass multiple memories contained in the same device or computer or distributed across multiple devices or computers. The memory 122 is considered to store a set of data, operational software, or information if the multiple memories collectively store the set of data, operational software, or information, even if different memories store different portions of the data, operational software, or information in the set.

The radios 124 may communicate messages or information using different communication technologies. For example, the access point 102, base station 104, and/or device 106 may use one or more of the radios 124 for WiFi communications or cellular communications. The access point 102, base station 104, and/or device 106 may use one or more of the radios 124 to transmit messages and one or more of the radios 124 to receive messages. The access point 102, base station 104, and/or device 106 may include any number of radios 124 to communicate using any number of communication technologies (e.g., Bluetooth, UWB, etc.).

FIG. 2 illustrates an example operation 200 performed by the system 100 of FIG. 1A. Generally, the access point 102 performs the operation 200. By performing the operation 200, the access point 102 determines whether a device 106 is allowed to use a particular transmission power and whether operating with that transmission power would cause the total transmit power of the device 106 to exceed a threshold.

The access point 102 begins by determining a location 202 of the device 106. The access point 102 may use any location or ranging technique to determine the location 202. For example, the device 106 may use a global positioning system to determine the geocoordinates of the device 106. The device 106 may then report the geocoordinates to the access point 102 as the location 202 of the device 106. As another example, the access point 102 and the device 106 may use a ranging technique (e.g., fine timing measurement (FTM) exchanges) or other techniques based on received signal strength indicators (RSSIs). These techniques may reveal the location of the device 106 relative to the access point 102. If the access point 102 is aware of the location of the access point 102 (e.g., using a global positioning system) or if the access point 102 can use triangulation with another device (e.g., another access point), then the access point 102 may determine the location 202 of the device 106 from this relative location.

The access point 102 then determines whether the device 106 is allowed to use a particular transmission power based on the location 202. The access point 102 may use AFC to determine what transmission power the device is allowed to use when communicating with the access point 102. The access point 102 may reference an AFC database using the location 202 to determine the transmission power that the device 106 is allowed to use when communicating with the access point 102. Typically, the device 106 is allowed to operate in a standard power mode and use a higher transmission power when communicating with the access point 102 if the device 106 is indoors. When the device 106 is outdoors, the device 106 may operate in a low power mode with a reduced transmit power.

The access point 102 determines a total power 204 that the device 106 would transmit if the device 106 uses the transmit power indicated by AFC when communicating with the access point 102. The total power 204 may be a sum of the various transmit powers used by the device 106 to communicate over different wireless mediums. For example, the total power 204 may be a sum of the transmit powers that the device 106 uses to communicate with the access point 102, the base station 104, and/or other communication protocols (e.g., Bluetooth and UWB). In some embodiments, the device 106 reports the total power 204 to the access point 102, or the device 106 reports the individual transmission powers to the access point 102, and the access point 102 sums the individual transmission powers to determine the total power 204.

The access point 102 compares the total power 204 with a threshold 206. The threshold 206 may be specified by legal regulations or requirements that limit the total transmit power of the device 106. In some embodiments, a cellular network (e.g., the base station 104) reports the threshold 206 to the access point 102 and the device 106. If the access point 102 determines that the total power 204 does not exceed the threshold 206, then the access point 102 may allow the device 106 to use the transmission power determined through AFC when communicating with the access point 102. For example, the access point 102 may allow the device 106 to operate in the standard power mode and use a higher transmission power if the total power 204 does not exceed the threshold 206.

If the total power 204 exceeds the threshold 206, then the access point 102 may take additional steps to reduce the total transmit power of the device 106 before the device 106 is allowed to use the transmit power determined through AFC when communicating with the access point 102. The access point 102 may generate the instruction 114 that indicates a total power 208 for the device 106. The total power 208 may fall below the threshold 206. As a result, the instruction 114 may instruct the device 106 to reduce the total transmit power of the device 106 to the total power 208 or below the total power 208. The access point 102 then communicates the instruction 114 to the device 106.

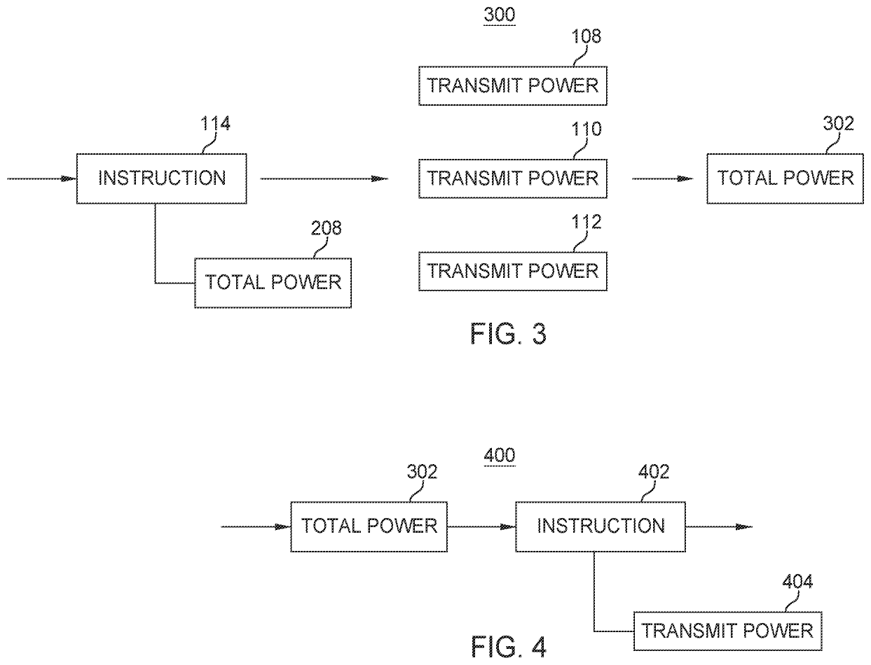

FIG. 3 illustrates an example operation 300 performed by the system 100 of FIG. 1A. Generally, the device 106 performs the operation 300. By performing the operation 300, the device 106 reduces a total transmit power of the device 106.

The device 106 receives the instruction 114 from the access point 102. The instruction 114 indicates that the device 106 should reduce the total transmit power of the device 106 to the total power 208. The device 106 may use different transmit powers for different communication protocols or technologies. For example, the device 106 may use a transmit power 108 when communicating with the access point 102, a transmit power 110 when communicating with the base station 104, and the transmit power 112 when communicating using other communication technologies (e.g., Bluetooth or UWB). The device 106 may reduce one or more of these transmit powers to reduce the total transmit power of the device 106. For example, the device 106 may reduce the transmit power 110 that the device 106 uses to communicate with the base station 104 in response to the instruction 114. The device 106 may also reduce the transmit power 112 to reduce the total transmit power of the device 106. By reducing the transmit power 110 or the transmit power 112, the device may reduce the total transmit power of the device 106 to a total power 302. The total power 302 may be less than or equal to the total power 208 indicated by the instruction 114. The device 106 may then inform the access point 102 that the device 106 has reduced the total transmit power of the device 106 to the total power 302.

FIG. 4 illustrates an example operation 400 performed by the system 100 of FIG. 1A. Generally, the access point 102 performs the operation 400. By performing the operation 400, the access pint 102 instructs the device 106 to use a transmission power determined through AFC when communicating with the access point 102.

The access point 102 receives the total power 302 from the device 106. The total power 302 may be the total transmit power of the device 106 after the device 106 reduces one or more of the individual transmit powers of the device 106. The total power 302 may fall below the threshold 206 set by legal regulations or requirements. When the access point 102 determines that the total power 302 falls below the threshold 206, the access point 102 generates an instruction 402 for the device 106. The instruction 402 indicates a transmit power 404. The transmit power 404 may have been determined through the AFC technique. The transmit power 404 may be the transmit power that the device 106 should use when communicating with the access point 102. The access point 102 communicates the instruction 402 to the device 106 to instruct the device 106 to increase the transmit power 108 used by the device 106 when communicating with the access point 102 to the transmit power 404.

In some embodiments, the instruction 402 is embodied within the instruction 114. For example, the instruction 114 may indicate both the total power 208 and the transmit power 404. When the device 106 receives the instruction 114, the device 106 may reduce the total transmit power of the device 106 to the total power 208. The device 106 may then increase the transmit power 108 used by the device 106 to communicate with the access point 102 to the transmit power 404 indicated in the instruction 114.

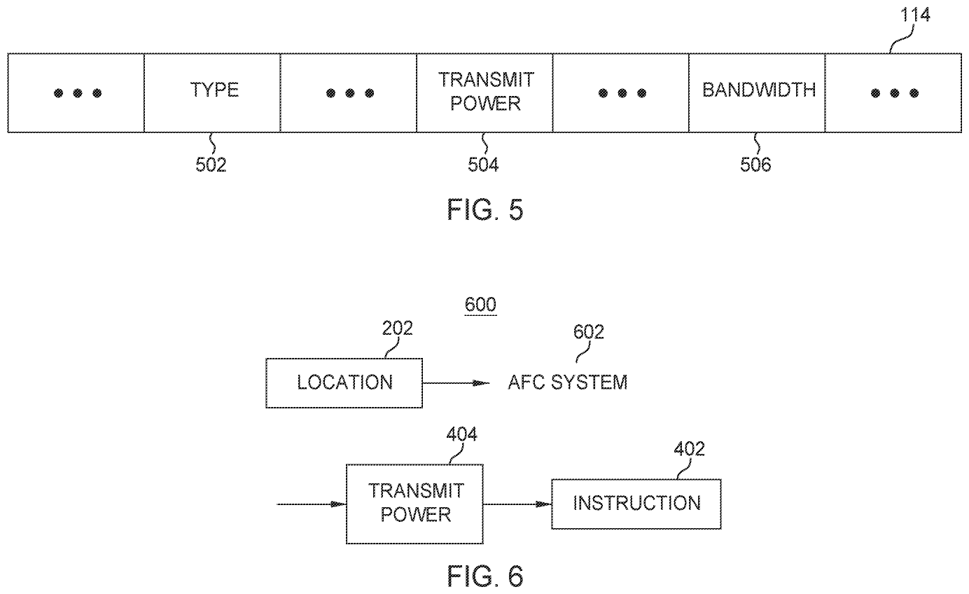

FIG. 5 illustrates an example instruction 114 in the system 100 of FIG. 1A. As seen in FIG. 5, the instruction 114 includes various fields. These fields may indicate the transmit powers that the device 106 should use.

As seen in FIG. 5, the instruction 114 indicates one or more types 502 and one or more transmit powers 504. Each type 502 indicates a type for a transmit power 504. For example, the type 502 may indicate cellular, Bluetooth, UWB, etc. The transmit power 504 corresponding to each type 502 may indicate a transmit power to be used for that particular type of communication protocol or process. For example, the instruction 114 may indicate a type 502 of cellular and a transmit power 504. As a result, the transmit power 504 may indicate the transmit power that the device 106 should use when communicating with the base station 104. As another example, the instruction 114 may also indicate a type 502 for Bluetooth and a transmit power 504. As a result, the transmit power 504 may indicate the transmit power that the device 106 should use when transmitting Bluetooth messages. The sum of the transmit powers 504 indicated in the instruction 114 may be the total power 208 for the device 106.

In certain embodiments, the access point 102 includes a bandwidth 506 in the instruction 114. The bandwidth 506 indicates the amount of bandwidth that the device 106 should use when communicating using a certain communication type (e.g., cellular). In this manner, the instruction 114 may instruct the device 106 to adjust the transmit power for cellular communications while also adjusting the bandwidth for the cellular communications. For example, the instruction 114 may instruct the device 106 to reduce the transmit power for cellular communications while increasing the bandwidth for cellular communications. In this manner, the device 106 may not experience a significant degradation in cellular communication quality when reducing the transmit power for cellular communications.

In some embodiments, the instruction 114 indicates the total power 208 instead of separating out into different communication types 502 and transmit powers 504. The instruction 114 may also indicate the bandwidth 506 in addition to the total power 208. In these instances, the access point 102 may expect that the device 106 will reduce the transmit power for cellular communications to reduce to the total transmit power of the device 106 to the total power 208 or below the total power 208. By providing the bandwidth 506, the access point 102 indicates to the device 106 that the device 106 may increase the bandwidth used for cellular communications while reducing the transmit power for cellular communications. In some embodiments, the access point 102 provides the bandwidth 506 when the device 106 indicates that the device 106 cannot reduce the total transmit power of the device 106 below the threshold (e.g., due to communication degradation). The access point 102 provides the bandwidth 506 to allow the device 106 to reduce the transmit power for cellular communication without experiencing as much communication degradation, which may allow the device 106 to reduce the total transmit power of the device to the threshold or below the threshold.

FIG. 6 illustrates an example operation 600 performed by the system 100 of FIG. 1A. Generally, the access point 102 performs the operation 600. By performing the operation 600, the access point 102 determines the transmit power 404 that the device 106 should use when communicating with the access point 102.

The access point 102 determines the location 202 of the device 106. For example, the device 106 may provide the access point 102 with the geocoordinates of the device 106. As another example, the access point 102 and the device 106 may use location or ranging techniques to determine the location 202 of the device 106. The access point 102 communicates the location 202 to an AFC system 602. The AFC system 602 may include a database that stores allowed WiFi transmission powers for different locations. The access point 102 may reference the database using the location 202 to determine the transmission powers that the device 106 is allowed to use to communicate with the access point 102. For example, the database may indicate that the device 106 should operate with lower WiFi transmission powers if the device 106 is outdoors so as to reduce interference with incumbent devices. As another example, the database may indicate that the device 106 may operation with higher WiFi transmission powers if the device 106 is indoors.

The access point 102 determines the transmit power 404 from the AFC system 602. The transmit power 404 may be the transmit power that the device 106 is allowed to use to communicate with the access point 102. For example, the AFC system 602 may reveal that the device 106 is allowed to operate in the standard power mode because the location 202 is indoors. The access point 102 may include the transmit power 404 in the instruction 402 and communicate the instruction 402 to the device 106 to instruct the device to use the transmit power 404.

Prior to communicating the transmit power 404 to the device 106 the access point 102 may first determine that the total transmit power of the device 106 will not exceed the threshold 206 if the device were to use the transmit power 404. If the total transmit power would exceed the threshold 206, the access point 102 may first instruct the device 106 to reduce the total transmit power of the device 106 before transmitting using the transmit power 404. The device 106 may reduce the total transmit power by reducing the transmit power for other communication types (e.g., cellular communications, Bluetooth communications, or UWB communications). After the device 106 has reduced the total transmit power, the device may transmit WiFi messages to the access point 102 using the transmit power 404. In this manner, the device 106 uses the transmit power 404 determined by the access point 102 without the total transmit power exceeding the threshold 206.

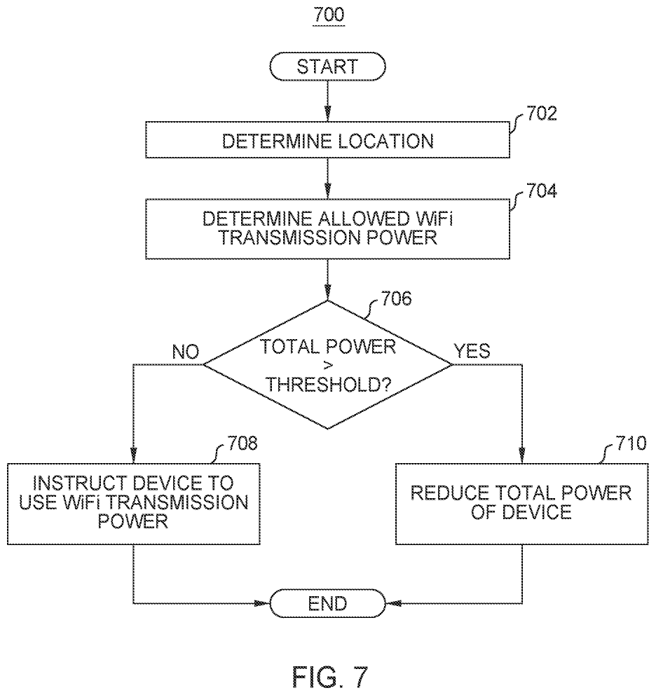

FIG. 7 is a flowchart of an example method 700 performed by the system 100 of FIG. 1A. In particular embodiments, the access point 102 performs the method 700. By performing the method 700, the access point 102 allows the device 106 to operate in the standard power mode with a higher transmit power without the total transmit power of the device 106 exceeding the threshold 206.

In block 702, the access point 102 determines the location 202 of the device 106. For example, the device 106 may use a global positioning system to determine the geocoordinates of the device 106. The device 106 may then report the geocoordinates to the access point 102 as the location 202 of the device 106. As another example, the access point 102 and the device 106 may use location or ranging techniques to determine the location of the device 106 relative to the access point 102. If the access point 102 knows the location of the access point 102 or if the access point 102 uses triangulation with other devices (e.g., other access points), then the access point 102 may determine the location 202 of the device 106 from this relative location.

In block 704, the access point 102 determines an allowed WiFi transmission power for the device 106. For example, the access point 102 may reference an AFC database using the location 202 to determine the WiFi transmission power that the device 106 is allowed to use. In some instances, the access point 102 may determine, from the location 202, that the total transmission power of the device 106 would exceed the threshold 206 if the device 106 were to use the WiFi transmission power determined in block 704. In some embodiments, the threshold 206 is provided by a cellular network (e.g., the base station 104). If the total transmit power of the device 106 would not exceed the threshold 206, the access point 102 instructs the device 106 to use the WiFi transmission power in block 708. The device 106 may then communicate with the access point 102 using the WiFi transmission power without the total transmit power exceeding the threshold 206.

If the total transmit power of the device 106 would exceed the threshold 206, the access point 102 reduces the total transmit power of the device 106 in block 710. For example, the access point 102 may communicate the instruction 114 to the device 106. The instruction 114 may indicate the total transmit power that the device 106 should have. The device 106 may reduce the total transmit power of the device 106 by reducing the transmit power of one of more radios of the device 106. For example, the device 106 may reduce the transmit power that the device 106 uses to transmit cellular messages. As another example, the device 106 may reduce the transmit power that the device 106 uses to transmit Bluetooth or UWB messages. As another example, the device 106 may reduce the transmit power that the device 106 uses to transmit to other WiFi access points in the system 100. After the device 106 reduces the total transit power, the device 106 may transmit messages to the access point 102 using the determined WiFi transmission power.

In summary, the access point 102 determines when a total transmission power of the device 106 would exceed legal regulations or requirements if the device 106 were to use a particular WiFi transmission power (e.g., a standard power mode). The access point 102 then instructs the device 106 to reduce the total transmission power so that the device 106 can use the WiFi transmission power. The device 106 may reduce the total transmission power (e.g., by reducing a transmission power of a cellular radio of the device 106). The device 106 may then use the WiFi transmission power to communicate with the access point 102.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
one or more memories; and
one or more processors communicatively coupled to the one or more memories, a combination of the one or more processors configured to:
determine a location of a first device;
determine, based on the location of the first device, that the first device is allowed to transmit using a first amount of power for a wireless fidelity (WiFi) radio of the first device; and
in response to determining that a total power transmitted by the first device would exceed a threshold transmission power if the first device transmitted using the first amount of power for the WiFi radio of the first device, reduce a power transmitted by at least one radio of the first device so that the first device is allowed to transmit using the first amount of power for the WiFi radio of the first device.

2. The access point of claim 1, wherein the combination of the one or more processors is further configured to, in response to determining that the first device reduced the total power transmitted by the first device, instruct the first device to transmit using the first amount of power for the WiFi radio of the first device.

3. The access point of claim 1, wherein reducing the total power transmitted by the first device comprises reducing a transmission power of a cellular radio of the first device.

4. The access point of claim 3, wherein the combination of the one or more processors is further configured to instruct the first device to increase a bandwidth of the cellular radio while reducing the transmission power of the cellular radio.

5. The access point of claim 1, wherein the threshold transmission power is reported by a cellular network.

6. The access point of claim 1, wherein determining that the first device is allowed to transmit using the first amount of power for the WiFi radio of the first device comprises referencing an automated frequency coordination database using the location of the first device.

7. The access point of claim 1, wherein the combination of the one or more processors is further configured to:
determine a location of a second device;
determine, based on the location of the second device, that the second device is allowed to transmit using a second amount of power for a WiFi radio of the second device; and
in response to determining that a total power transmitted by the second device would fall below the threshold transmission power if the second device transmitted using the second amount of power for the WiFi radio of the second device, instruct the second device to transmit using the second amount of power for the WiFi radio of the second device.

8. A method comprising:
determining, by an access point, a location of a first device;
determining, by the access point and based on the location of the first device, that the first device is allowed to transmit using a first amount of power for a wireless fidelity (WiFi) radio of the first device; and
in response to determining that a total power transmitted by the first device would exceed a threshold transmission power if the first device transmitted using the first amount of power for the WiFi radio of the first device, reducing a power transmitted by at least one radio of the first device so that the first device is allowed to transmit using the first amount of power for the WiFi radio of the first device.

9. The method of claim 8, further comprising, in response to determining that the first device reduced the total power transmitted by the first device, instructing the first device to transmit using the first amount of power for the WiFi radio of the first device.

10. The method of claim 8, wherein reducing the total power transmitted by the first device comprises reducing a transmission power of a cellular radio of the first device.

11. The method of claim 10, further comprising instructing the first device to increase a bandwidth of the cellular radio while reducing the transmission power of the cellular radio.

12. The method of claim 8, wherein the threshold transmission power is reported by a cellular network.

13. The method of claim 8, wherein determining that the first device is allowed to transmit using the first amount of power for the WiFi radio of the first device comprises referencing an automated frequency coordination database using the location of the first device.

14. The method of claim 8, further comprising:
determining a location of a second device;
determining, based on the location of the second device, that the second device is allowed to transmit using a second amount of power for a WiFi radio of the second device; and
in response to determining that a total power transmitted by the second device would fall below the threshold transmission power if the second device transmitted using the second amount of power for the WiFi radio of the second device, instructing the second device to transmit using the second amount of power for the WiFi radio of the second device.

15. A non-transitory computer readable medium storing instructions that, when executed by a combination of one or more processors, cause the combination of one or more processors to:
determine a location of a first device;
determine, based on the location of the first device, that the first device is allowed to transmit using a first amount of power for a wireless fidelity (WiFi) radio of the first device; and
in response to determining that a total power transmitted by the first device would exceed a threshold transmission power if the first device transmitted using the first amount of power for the WiFi radio of the first device, reduce a power transmitted by at least one radio of the first device so that the first device is allowed to transmit using the first amount of power for the WiFi radio of the first device.

16. The medium of claim 15, wherein the instructions further cause the combination of the one or more processors to, in response to determining that the first device reduced the total power transmitted by the first device, instruct the first device to transmit using the first amount of power for the WiFi radio of the first device.

17. The medium of claim 15, wherein reducing the total power transmitted by the first device comprises reducing a transmission power of a cellular radio of the first device.

18. The medium of claim 17, wherein the instructions further cause the combination of the one or more processors to instruct the first device to increase a bandwidth of the cellular radio while reducing the transmission power of the cellular radio.

19. The medium of claim 15, wherein the threshold transmission power is reported by a cellular network.

20. The medium of claim 15, wherein determining that the first device is allowed to transmit using the first amount of power for the WiFi radio of the first device comprises referencing an automated frequency coordination database using the location of the first device.
